(19) United States
(12) Patent Application Publication
(10) Pub. No.: US 2021/0138648 A1
(43) Pub. Date: May 13, 2021

(54) INTERACTIVE CONTROL METHOD OF ROBOT EQUIPMENT AND ELEVATOR EQUIPMENT

(71) Applicant: New Era AI Robotic Inc., Taipei City (TW)

(72) Inventors: Cho-Han Chang, Taipei City (TW); Ping-Han Liang, Taipei City (TW); Li Chi, Taipei City (TW); Chien-Chih Weng, Taipei City (TW); Tien-Ping Liu, Taipei City (TW)

(73) Assignee: New Era AI Robotic Inc., Taipei City (TW)

(21) Appl. No.: 17/001,659

(22) Filed: Aug. 24, 2020

(30) Foreign Application Priority Data
Nov. 13, 2019 (TW) 108141203

(51) Int. Cl. B25J 9/16; B66B 1/24

(52) U.S. Cl. CPC B25J 9/1666; B66B 1/2408; B66B 2201/222; B25J 9/1669; B66B 2201/215; B25J 9/1697

(57) ABSTRACT

An interactive control method is provided. The interactive control method includes the following steps. When robot equipment is located outside elevator equipment, the robot equipment is connected to a first control module disposed outside the elevator equipment to call, by the first control module, an elevator car of the elevator equipment. The first control module determines whether the elevator car arrives at a current floor to return an arrival signal to the robot equipment. The robot equipment is connected to a second control module disposed inside the elevator car according to the arrival signal to control, by the second control module, an elevator door of the elevator car to open. The robot equipment is driven to move into the elevator car. When the robot equipment is located within a working range of the elevator car, the second control module stops controlling the elevator door of the elevator car to open.

### CROSS-REFERENCE TO RELATED APPLICATION

This application claims the priority benefit of Taiwan application no. 108141203, filed on Nov. 13, 2019. The entirety of the above-mentioned patent application is hereby incorporated by reference herein and made a part of this specification.

### BACKGROUND OF THE INVENTION

### Field of the Invention

The disclosure relates to a control method, and more particularly, to an interactive control method of robot equipment and elevator equipment.

### Description of Related Art

Recently, more and more robot equipment has been applied to various occasions such as factories, stores, or homes to provide the corresponding automatic control functions. However, the current robot equipment can only be operated to work in areas on the same plane to provide specific functions. As specific requirements increase, if the robot equipment is required to work in areas on different floor planes, such requirement cannot be satisfied because the current robot equipment cannot automatically move between different floor planes. In view of the above, solutions of several embodiments will be presented below.

### SUMMARY OF THE INVENTION

The invention provides an interactive control method of robot equipment and elevator equipment, which can enable the robot equipment to realize the function of automatically moving into and out of the elevator equipment.

An interactive control method of robot equipment and elevator equipment of the invention includes the following steps. When the robot equipment is located outside the elevator equipment, the robot equipment is connected to a first control module disposed outside the elevator equipment to call, by the first control module, an elevator car of the elevator equipment. The first control module determines whether the elevator car arrives at a current floor to return an arrival signal to the robot equipment. The robot equipment is connected to a second control module disposed inside the elevator car according to the arrival signal to control, by the second control module, an elevator door of the elevator car to open. An image detection device of the robot equipment determines whether the elevator door of the elevator car is fully opened to drive the robot equipment to move into the elevator car. When the robot equipment is located within a working range of the elevator car, the second control module stops controlling the elevator door of the elevator car to open.

Based on the above, in the interactive control method of the robot equipment and the elevator equipment of the invention, the robot equipment can automatically call the elevator car of the elevator equipment, and the elevator door of the elevator car is operated to open or close to allow the robot equipment to move into or out of the elevator car.

To make the aforementioned more comprehensible, several embodiments accompanied with drawings are described in detail as follows.

### BRIEF DESCRIPTION OF THE DRAWINGS

FIG. 1 is a block diagram of robot equipment according to an embodiment of the invention.

FIG. 2 is a block diagram of elevator equipment and a first control module according to an embodiment of the invention.

FIG. 3 is a block diagram of an elevator car and a second control module according to an embodiment of the invention.

FIG. 4 is a schematic top view showing the robot equipment entering the elevator car according to an embodiment of the invention.

FIG. 5 is a flowchart of an interactive control method according to an embodiment of the invention.

FIG. 6 is a flowchart of determination on whether the elevator door is open according to an embodiment of the invention.

FIG. 7 is a flowchart of controlling the robot equipment to move into the elevator car according to an embodiment of the invention.

FIG. 8 is a flowchart of controlling the robot equipment to move out of the elevator car according to an embodiment of the invention.

### DESCRIPTION OF THE EMBODIMENTS

To make the content of the invention more comprehensible, embodiments are provided below as examples for the invention to be implemented accordingly. In addition, wherever possible, the same elements, components, and steps labeled with the same numerals in the drawings and embodiments represent the same or similar components.

FIG. 1 is a block diagram of robot equipment according to an embodiment of the invention. Referring to FIG. 1, robot equipment 100 includes a processor 110, a first wireless communication device 120, a second wireless communication device 130, and an image detection device 140. The processor 110 is coupled to the first wireless communication device 120, the second wireless communication device 130, and the image detection device 140. In the present embodiment, the robot equipment 100 is automatic control equipment having an automatic movement function, and the invention does not specifically limit the form of the robot equipment 100. In the present embodiment, the robot equipment 100 is configured to respectively communicate with a control module outside the elevator equipment and a control module inside the elevator car through the first wireless communication device 120 and the second wireless communication device 130 and perform image recognition with the image detection device 140 to realize the function of automatic control of movement of the robot equipment 100 into and out of the elevator car.

In the present embodiment, the processor 110 may be, for example, a central processing unit (CPU), or another programmable general-purpose or specific-purpose microprocessor, digital signal processor (DSP), programmable controller, application specific integrated circuit (ASIC), programmable logic device (PLD), another similar processing device, or a combination of the above devices. In the present embodiment, the processor 110 may include one or more processing circuits to perform, for example, automatic control commands, image processing operations, etc. and may be further coupled to a memory. The memory may store data such as control commands, programs, or images for the processor 110 to read and execute. In the present embodiment, the image detection device 140 may be configured to obtain an image in front of the robot equipment 100, so that the processor 110 can perform relevant image determination operations. The image detection device 140 may be, for example, a camera. In addition, in an embodiment, the robot equipment 100 may further include other devices such as a driving module, a battery module, etc., which are configured to realize the automatic movement function, or other devices such as a voice device, a display device, etc., which are configured to provide voice and display functions.

FIG. 2 is a block diagram of elevator equipment and a first control module according to an embodiment of the invention. In the present embodiment, a first control module 210 includes a controller 211, a wireless communication device 212, a relay 213, a boost and voltage regulator circuit 214, and a cable module 215. The controller 211 may be, for example, a microcontroller. The controller 211 is coupled to the wireless communication device 212 and the relay 213. The relay 213 is coupled to the boost and voltage regulator circuit 214, and the boost and voltage regulator circuit 214 is coupled to the cable module 215. In the present embodiment, the elevator equipment 220 includes a direction button module 221. The direction button module 221 may include, for example, an up button and a down button outside the elevator equipment 220, but the invention is not limited thereto. The controller 211 is coupled to the direction button module 221 of the elevator equipment 220 through the relay 213, the boost and voltage regulator circuit 214, and the cable module 215 to control the direction button module 221.

Referring to FIG. 1 and FIG. 2, in the present embodiment, when the robot equipment 100 is moved to a specific position outside the elevator equipment 220 and corresponding to the elevator equipment 220, the robot equipment 100 communicates with the wireless communication device 212 of the first control module 210 through the first wireless communication device 120 to provide relevant control commands to the controller 211 of the first control module 210, so that the controller 211 correspondingly operates the direction button module 221 of the elevator equipment 220. It is noted that if the direction button module 221 includes the up button and the down button of the elevator, the controller 211 may enable the up button or the down button through the relay 213, the boost and voltage regulator circuit 214, and the cable module 215 to call the elevator car or keep the elevator door of the elevator car open.

For example, the first control module 210 may be coupled to a signal line and a light emitting element of the direction button of the elevator equipment 220. The first control module 210 may enable the signal line of the direction button to call the elevator car, and the first control module 210 may determine whether the elevator car arrives according to the lighting state of the light emitting element of the direction button.

Furthermore, it is noted that the first wireless communication device 120 and the wireless communication device 212 of the present embodiment may adopt the communication protocol of WiFi, Bluetooth, or ZigBee to perform wireless communication operations. Also, in an exemplary embodiment, the first wireless communication device 120 and the wireless communication device 212 adopt the communication protocol of ZigBee to perform wireless communication operations. In addition, the first control module 210 of the present embodiment is disposed outside the elevator equipment 220 and is electrically connected to relevant elevator control buttons of the elevator equipment 220 in a plug-in manner. The invention does not specifically limit the specific configuration location of the first control module 210 outside the elevator equipment 220.

FIG. 3 is a block diagram of an elevator car and a second control module according to an embodiment of the invention. In the present embodiment, a second control module 310 includes a controller 311, a wireless communication device 312, a relay 313, a boost and voltage regulator circuit 314, and a cable module 315. The controller 311 may be, for example, a microcontroller. The controller 311 is coupled to the wireless communication device 312 and the relay 313. The relay 313 is coupled to the boost and voltage regulator circuit 314, and the boost and voltage regulator circuit 314 is coupled to the cable module 315. In the present embodiment, an elevator car 320 includes an opening/closing button module 321 and a floor button module 322. The elevator equipment 220 of FIG. 2 includes the elevator car 320 of the present embodiment. In the present embodiment, the opening/closing button module 321 may include, for example, an opening button and a closing button inside the elevator car 320, and the floor button module 322 may include, for example, each floor button inside the elevator car 320, but the invention is not limited thereto. The controller 311 is coupled to the opening/closing button module 321 and the floor button module 322 of the elevator car 320 through the relay 313, the boost and voltage regulator circuit 314, and the cable module 315 to control the opening/closing button module 321 and the floor button module 322. In the present embodiment, the elevator car 320 may further include other devices such as a floor display panel configured to display the current floor location of the elevator car 320.

FIG. 4 is a schematic top view showing the robot equipment entering the elevator car according to an embodiment of the invention. Referring to FIG. 1 to FIG. 4, the first control module 210 may be disposed, for example, at a location outside the elevator equipment 220 shown in FIG. 4, and the second control module 310 may be disposed, for example, at a location inside the elevator car 320 shown in FIG. 4. Moreover, the inside of the elevator car 320 further includes augmented reality (AR) labels 323 and 324 and a floor display panel 325. The robot equipment 100 moves, for example, on a plane formed by a horizontal direction X and a horizontal direction Y. The AR label 323 is located, for example, on a car inner wall parallel to a plane formed by the horizontal direction X and a vertical direction Z. The AR label 324 and the floor display panel 325 are located, for example, on another car inner wall parallel to a plane formed by the horizontal direction Y and the vertical direction Z.

In the present embodiment, when the robot equipment 100 moves into the elevator car 320, the robot equipment 100 communicates with the wireless communication device 312 of the second control module 310 through the second wireless communication device 130 to provide relevant control commands to the controller 311 of the second control module 310, so that the controller 311 correspondingly operates the opening/closing button module 321 and the floor button module 322 of the elevator car 320. It is noted that if the opening/closing button module 321 includes the opening button and the closing button of the elevator, the controller 311 may enable the opening button or the closing button through the relay 313, the boost and voltage regulator circuit 314, and the cable module 315 to keep an elevator door 326 of the elevator car 320 open or closed. Moreover, if the floor button module 322 includes a plurality of floor buttons, the controller 311 may enable one of the plurality of floor buttons corresponding to a target floor through the relay 313, the boost and voltage regulator circuit 314, and the cable module 315, so that the elevator car 320 can move toward the target floor after the elevator door 326 is closed.

For example, the second control module 310 may be coupled to the signal line of the door opening button inside the elevator car 320, and the second control module 310 may enable the signal line of the door opening button to control the elevator door 326 of the elevator car 320 to open. Moreover, the second control module 310 may be coupled to the signal line and the light emitting element of the floor button inside the elevator car 320. The second control module 310 may enable the signal line of the floor button to control the elevator car 320 to move toward the target floor. Moreover, the second control module 310 may determine whether the elevator car 320 arrives at the target floor according to the lighting state of the light emitting element of the floor button.

Furthermore, it is noted that the second wireless communication device 130 and the wireless communication device 312 of the present embodiment may adopt a communication protocol of WiFi, Bluetooth, or ZigBee to perform wireless communication operations. Moreover, in an exemplary embodiment, the second wireless communication device 130 and the wireless communication device 312 adopt the communication protocol of Bluetooth to perform wireless communication operations. In another embodiment, the first wireless communication device 120 and the second wireless communication device 130 may also adopt the same or different wireless communication protocols, or the first wireless communication device 120 and the second wireless communication device 130 may even be the same wireless communication unit. In addition, the second control module 310 of the present embodiment is disposed inside the elevator car 320 and is electrically connected to relevant elevator control buttons of the elevator car 320 in a plug-in manner. The invention does not specifically limit the specific configuration location of the second control module 310 inside the elevator car 320.

FIG. 5 is a flowchart of an interactive control method according to an embodiment of the invention. Referring to FIG. 1 to FIG. 5, the interactive control method of the present embodiment may be applied to the devices and equipment of the embodiments of FIG. 1 to FIG. 4. In step S401, the robot equipment 100 is connected to the first control module 210 disposed outside the elevator equipment 220 through the first wireless communication device 120 to wirelessly communicate with and control the first control module 210. In step S402, the robot equipment 100 controls the first control module 210, and enables the direction button module 221 of the elevator equipment 220 through the first control module 210 to call the elevator car 320 of the elevator equipment 220. In step S403, the first control module 210 determines whether the elevator car 320 arrives at a current floor. For example, the first control module 210 may effectively determine whether the elevator car 320 arrives at the current floor by determining whether the direction button module 221 is off. If not, the first control module 210 performs step S403 again to continue the determination. If yes, the first control module 210 performs step S404 to return an arrival signal to the robot equipment 100. In step S405, the robot equipment 100 is connected to the second control module 310 disposed inside the elevator car 320. In an embodiment, when the robot equipment 100 is successfully connected to the second control module 310, the connection with the first control module 210 may be disconnected or may be maintained until it is automatically disconnected, and the invention is not limited thereto.

In step S406, the robot equipment 100 outputs a control command to the second control module 310 to control the elevator door 326 of the elevator car 320 to open through the second control module 310. In step S407, the robot equipment 100 obtains a current elevator door image of the elevator car 320 through the image detection device 140 to determine whether the elevator door 326 of the elevator car 320 is fully opened. If not, the robot equipment 100 performs step S407 again to continue the determination. If yes, the robot equipment 100 performs step S408 to obtain a current in-car image of the elevator car 320 through the image detection device 140, and further determine whether an obstacle is present within a working range 327 in the elevator car 320, and the obstacle may be, for example, a person or an object. If yes, the robot equipment 100 performs step S409 and step S412 to wait for the next arrival of the elevator car 320. In other words, if there is no space in the elevator car 320, the robot equipment 100 can wait for the next elevator. If not, the robot equipment 100 performs step S410 to drive the robot equipment 100 to move into the elevator car 320.

In step S411, the robot equipment 100 detects the AR label 323 inside the elevator car 320 through the image detection device 140, so that the processor 110 can establish a corresponding spatial model inside the elevator car 320 and correspondingly drive and adjust the position or angle of the robot equipment 100. Specifically, according to the AR label 323, the robot equipment 100 may calculate the corresponding posture information and position information of the AR label 323 in the image taken by the image detection device 140. Next, according to the posture information and the position information, the robot equipment 100 estimates the coordinate data of the working range 327 in the image obtained by the image detection device 140. Finally, the robot equipment 100 may determine the working range 327 inside the elevator car 320 according to the coordinate data. It is noted that the AR label 323 is configured to allow the robot equipment 100 to obtain the position and size of the working range 327. Based on the pixel size, position, and posture of the AR label 323 (of which the actual size is known) shown in the image, the posture information and position information of the AR label 323 in the real world relative to the robot equipment 100 is calculated according to the camera imaging principle, and at the same time, the coordinate data of the working range 327 in the image is estimated, so that the robot equipment 100 can obtain the actual position and actual size of the working range 327 inside the elevator car 320 according to the above data.

In step S412, when the robot equipment 100 finishes step S411, the robot equipment 100 may first enable the floor button module 322 through the second control module 310, and then stop enabling the opening/closing button module 321 of the elevator car 320 to stop controlling the elevator door 326 of the elevator car 320 to open, so that the elevator car 320 can move toward the target floor according to the selection result of the floor button module 322. Therefore, the interactive control method of the present embodiment may enable the robot equipment 100 to realize the function of automatically taking the elevator.

FIG. 6 is a flowchart of determination on whether the elevator door is open according to an embodiment of the invention. Referring to FIG. 1 to FIG. 6, the process of determining whether the elevator door 326 is open in the present embodiment may be the detailed implementation method of step S407 of FIG. 5. In step S501, the processor 110 of the robot equipment 100 reads a pre-stored elevator door gap template image and obtains a current elevator door gap image (which comes from the current elevator door image) of the elevator car 320 through the image detection device 140. In step S502, the processor 110 of the robot equipment 100 matches the current elevator door gap image and the elevator door gap template image to identify whether the current elevator door gap of the elevator car 320 is greater than a predetermined threshold value. If not, the robot equipment 100 performs step S502 again to continue the identification. If yes, the robot equipment 100 performs step S504 to determine that the elevator door 326 of the elevator car 320 has been opened. In the present embodiment, the predetermined threshold value may be 70% or 80% of a horizontal length of the elevator door 326, or may be a gap ratio of the elevator door 326 which at least can accommodate the robot equipment 100 to pass. Therefore, the process of the present embodiment may enable the robot equipment 100 to effectively determine whether the elevator door 326 of the elevator car 320 has been opened to a sufficient width to allow the robot equipment 100 to move into the elevator car 320.

FIG. 7 is a flowchart of controlling the robot equipment to move into the elevator car according to an embodiment of the invention. Referring to FIG. 1 to FIG. 5 and FIG. 7, the process of controlling the robot equipment 100 to move into the elevator car 320 of the present embodiment may be the detailed implementation method of step S408 of FIG. 5. In step S601, the robot equipment 100 detects the AR label 323 inside the elevator car 320 through the image detection device 140. In step S602, the robot equipment 100 performs object recognition on the inside the elevator car 320 through the image detection device 140. In step S603, the processor 110 of the robot equipment 100 determines whether the AR label 323 is detected. If not, it means that there is a person or an object in the elevator car 320 that blocks the AR label 323, so the robot equipment 100 performs step S607. If yes, the processor 110 of the robot equipment 100 estimates the working range 327 according to the AR label 323.

In step S605, the robot equipment 100 determines whether an obstacle is present within the working range 327 through the previous object recognition. If not, the robot equipment 100 performs step S609 to cause the processor 110 to issue an elevator entry command. If yes, the robot equipment 100 performs step S606 to further detect whether there is still space inside the elevator car 320 through the image detection device 140. If not, the robot equipment 100 performs step S610 to wait for the next arrival of the elevator car 320. If yes, the robot equipment 100 performs step S607. In step S607, the processor 110 of the robot equipment 100 determines whether a voice message has been played. If not, the robot equipment 100 performs step S608 to play the voice message through a voice device and then performs step S601 again. If yes, the robot equipment 100 performs step S610 to wait for the next arrival of the elevator car 320.

In other words, the robot equipment 100 of the present embodiment may emit a one-time voice prompt to prompt the obstacle within the working range 327. If the obstacle is a person, the person may make room for the robot equipment 100 according to the voice prompt. On the other hand, when the obstacle is an object, or the person does not want to make room for the robot equipment 100, after issuing the one-time voice prompt, if the robot equipment 100 determines that the space of the working range 327 is still occupied, the robot equipment 100 will wait for the next elevator car 320. Therefore, the process of the present embodiment may effectively ensure that the robot equipment 100 can properly enter the elevator car 320.

FIG. 8 is a flowchart of controlling the robot equipment to move out of the elevator car according to an embodiment of the invention. Referring to FIG. 1 to FIG. 4 and FIG. 8, the interactive control method of the present embodiment may be applied to the devices and equipment of the embodiments of FIG. 1 to FIG. 4. In step S701, after the robot equipment 100 enters the elevator car 320 (e.g., following step S412 of FIG. 4), the robot equipment 100 turns to the floor display panel 325 of the elevator car 320. In step S702, the robot equipment 100 detects the AR label 324 inside the elevator car 320 through the image detection device 140 to adjust the robot equipment 100 to face the floor display panel 325 of the elevator car 320 according to the AR label 324 inside the elevator car 320. In step S703, the robot equipment 100 determines through the image detection device 140 whether the robot equipment 100 is properly oriented toward the floor display panel 325. If not, the robot equipment 100 performs step S701 again to continue to adjust the position and angle of the robot equipment 100. If yes, the robot equipment 100 performs step S704. It is noted that the AR label 324 serves as a position basis for turning the robot equipment 100, so that the image detection device 140 of the robot equipment 100 can capture an image and perform recognition toward the floor display panel 325. Also, since the robot equipment 100 of the present embodiment turns within the working range 327, the length and the width of the working range 327 of the present embodiment are greater than or equal to the length of the diagonal line of the robot equipment 100.

In step S704, the robot equipment 100 remotely controls the second control module 310 to enable the floor button module through the second wireless communication device 130 to control the elevator car 320 to move toward the target floor. In step S705, the robot equipment 100 captures an image of the floor display panel 325 through the image detection device 140 to obtain a current image of the floor display panel 325. In step S706, the processor 110 of the robot equipment 100 analyzes the image to recognize the elevator floor number displayed by the floor display panel 325. In step S707, the processor 110 of the robot equipment 100 determines whether the elevator car 320 arrives at the target floor. If not, the robot equipment 100 performs step S705 again to continue the determination. If yes, the robot equipment 100 performs step S708.

In step S708, the robot equipment 100 turns to the elevator door. In step S709, the robot equipment 100 obtains a current elevator door image of the elevator car 320 through the image detection device 140 to determine whether the elevator door 326 of the elevator car 320 is fully opened. If not, the robot equipment 100 performs step S709 again to continue the determination. If yes, the robot equipment 100 performs step S710 to control the elevator door 326 of the elevator car 320 to remain opened through the second control module 310. It is noted that the process of FIG. 6 may also be applied to step S709 of the present embodiment. Next, in step S711, the robot equipment 100 moves toward outside the elevator car 320. In step S712, after the robot equipment 100 completely leaves the elevator car 320, the robot equipment 100 stops controlling the elevator door 326 of the elevator car 320 to open. Therefore, the process of the present embodiment may enable the robot equipment 100 to realize the function of automatically moving out of the elevator.

In summary of the above, in the interactive control method of the robot equipment and the elevator equipment of the invention, the robot equipment may automatically call the elevator car of the elevator equipment, correspondingly control the elevator door of the elevator car to open or close, and drive the robot equipment to properly move into and out of the elevator car based on image detection. Moreover, the interactive control method of the robot equipment and the elevator equipment of the invention can further effectively determine whether an obstacle is present in the elevator car and emit a voice prompt, which enhances the chance and efficiency for the robot equipment to properly move into and out of the elevator car.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An interactive control method of robot equipment and elevator equipment, comprising:
when the robot equipment is located outside the elevator equipment, connecting the robot equipment to a first control module disposed outside the elevator equipment to call, by the first control module, an elevator car of the elevator equipment;
determining, by the first control module, whether the elevator car arrives at a current floor to return an arrival signal to the robot equipment;
connecting the robot equipment to a second control module disposed inside the elevator car according to the arrival signal to control, by the second control module, an elevator door of the elevator car to open;
determining, by an image detection device of the robot equipment, whether the elevator door of the elevator car is fully opened to drive the robot equipment to move into the elevator car; and
when the robot equipment is located within a working range of the elevator car, stopping controlling, by the second control module, the elevator door of the elevator car to open.

2. The interactive control method according to claim 1, wherein the step of determining, by the image detection device of the robot equipment, whether the elevator door of the elevator car is fully opened to drive the robot equipment to move into the elevator car comprises:
reading an elevator door gap template image by the robot equipment, and obtaining a current elevator door gap image by the image detection device;
matching, by the robot equipment, the current elevator door gap image and the elevator door gap template image to identify a current door gap of the elevator door of the elevator car; and
determining, by the robot equipment, whether the current door gap is greater than a predetermined threshold value to determine that the elevator door of the elevator car has been fully opened.

3. The interactive control method according to claim 1, wherein the step of determining, by the image detection device of the robot equipment, whether the elevator door of the elevator car is fully opened to drive the robot equipment to move into the elevator car comprises:
detecting, by the image detection device, an augmented reality label inside the elevator car, and performing an object recognition on inside of the elevator car;
estimating, by the robot equipment, the working range in the elevator car according to the augmented reality label; and
detecting, by the image detection device, whether an obstacle is present within the working range to determine whether to drive the robot equipment to move into the elevator car.

4. The interactive control method according to claim 3, wherein the step of estimating, by the robot equipment, the working range in the elevator car according to the augmented reality label comprises:
calculating, by the robot equipment, posture information and position information of the augmented reality label according to the augmented reality label;
estimating, by the robot equipment, coordinate data of the working range in an image obtained by the image detection device according to the posture information and the position information; and
determining, by the robot equipment, the working range in the elevator car according to the coordinate data.

5. The interactive control method according to claim 3, wherein the step of detecting, by the image detection device, whether the obstacle is present within the working range to determine whether to drive the robot equipment to move into the elevator car comprises:
when the robot equipment determines that the obstacle is present within the working range, detecting, by the image detection device of the robot equipment, whether there is still space in the elevator car to determine whether to drive the robot equipment to move into the elevator car; and
when the robot equipment determines that the obstacle is not present within the working range, driving the robot equipment to move toward the working range in the elevator car.

6. The interactive control method according to claim 5, wherein when the robot equipment determines that the obstacle is present within the working range, the step of detecting, by the image detection device of the robot equipment, whether there is still space in the elevator car comprises:
when there is still space in the elevator car, playing a voice message by the robot equipment, and determining again whether the obstacle is still present within the working range; and
when there is no space in the elevator car, operating the robot equipment to wait for a next arrival of the elevator car.

7. The interactive control method according to claim 1, wherein the first control module is coupled to a signal line and a light emitting element of a direction button of the elevator equipment, wherein the first control module enables the signal line of the direction button to call the elevator car, and the first control module determines whether the elevator car arrives according to a lighting state of the light emitting element of the direction button.

8. The interactive control method according to claim 1, wherein the second control module is coupled to a signal line of a door opening button inside the elevator car, and the second control module enables the signal line of the door opening button to control the elevator door of the elevator car to open.

9. The interactive control method according to claim 1, further comprising:
controlling, by the second control module, the elevator car to move toward a target floor;
determining, by the second control module, a current floor on which the elevator car is currently located;
detecting, by the image detection device, a floor display panel inside the elevator car to recognize an elevator floor number;
determining, by the robot equipment, whether the elevator car arrives at the target floor according to the current floor on which the elevator car is located and the elevator floor number;
when the robot equipment determines that the elevator car arrives at the target floor, controlling, by the second control module, the elevator door of the elevator car to open; and
determining, by the image detection device, whether the elevator door of the elevator car is fully opened to drive the robot equipment to move toward outside the elevator car.

10. The interactive control method according to claim 9, wherein the step of determining, by the image detection device, whether the elevator door of the elevator car is fully opened to drive the robot equipment to move toward outside the elevator car comprises:
reading an elevator door gap template image by the robot equipment, and obtaining a current elevator door gap image by the image detection device of the robot equipment;
determining, by the robot equipment, whether the current elevator door gap image matches the elevator door gap template image to identify a current door gap of the elevator door of the elevator car; and
determining, by the robot equipment, whether the current door gap is greater than a predetermined threshold value to determine that the elevator door of the elevator car has been fully opened.

11. The interactive control method according to claim 9, further comprising:
when the robot equipment has completely moved out of the elevator equipment, stopping controlling, by the second control module, the elevator door of the elevator car to open.

12. The interactive control method according to claim 9, further comprising:
detecting, by the image detection device of the robot equipment, the floor display panel inside the elevator car; and
driving the robot equipment to turn to the floor display panel, and adjusting, by the robot equipment, the robot equipment to face the floor display panel according to an augmented reality label inside the elevator car.

13. The interactive control method according to claim 12, wherein when the robot equipment determines that the elevator car arrives at the target floor, the step of controlling, by the second control module, the elevator door of the elevator car to open comprises:
driving the robot equipment to turn to the elevator door.

14. The interactive control method according to claim 9, wherein the second control module is coupled to a signal line and a light emitting element of a floor button inside the elevator car, wherein the second control module enables the signal line of the floor button to control the elevator car to move toward the target floor, and the second control module determines whether the elevator car arrives at the target floor according to a lighting state of the light emitting element of the floor button.

15. The interactive control method according to claim 9, wherein the second control module is coupled to a signal line of a door opening button inside the elevator car, and the second control module enables the signal line of the door opening button to control the elevator door of the elevator car to open.
